(19) United States
(12) Patent Application Publication
(10) Pub. No.: US 2015/0241761 A1
(43) Pub. Date: Aug. 27, 2015

(54) Removable Lens Protectors for Cameras

(71) Applicant: Stephany Llewellyn, Heber, UT (US)

(72) Inventor: Stephany Llewellyn, Heber, UT (US)

(21) Appl. No.: 14/190,062

(22) Filed: Feb. 25, 2014

(51) Int. Cl. G03B 17/56

(52) U.S. Cl. CPC G03B 17/568

(57) ABSTRACT

A stack of tear-away lens protectors and mounting assemblies may be mounted over a camera lens such that the stack of tear-away lens protectors may be easily removable one at a time to clear dirt, debris, and obstructions from covering the camera lens.

### PRIORITY

This application claims priority to U.S. Provisional Patent Application No. 61/768,733, filed on Feb. 25, 2014 and entitled Removable Lens Protectors for Cameras, which is hereby incorporated by reference in its entirety.

### FIELD

This application relates generally to mobile compact cameras. In particular, this application relates to removable, or tear-away lens protector film mounted on a mobile action camera to provide instant cleaning of the camera lens.

### BACKGROUND

Personal, mobile, compact, and wearable or mountable cameras, such a GoPro® products have been used recently to record various sports and outdoors activities. Compact cameras have been carried or mounted by people doing all types of sports and extreme sports such as auto racing, motorcycle racing, surfing, bicycling, paragliding, running, boat racing, and numerous other activities. For example, people use wearable cameras to capture and document the intensity of motocross racing from the rider's perspective. The use of these cameras in the off-road environment often leads to dirt and debris accumulating on the lens surface of the camera. This substantially reduces visibility when documenting and degrades the experience of later viewing the footage when a portion or all of the lens was covered with debris.

### SUMMARY

Accordingly, embodiments are described herein that provide a stack of tear-away lens protectors mounted over the camera lens with a mounting assembly such that the stack of tear-away lens protectors may be easily removable one at a time to clear dirt, debris, and obstructions for the camera lens.

In some embodiments, an assembly for mounting removable protectors to a camera may include a mounting assembly with a frame configured to be mounted to a camera, film mounts extending from the frame, and a stack of protective film layers configured to be mounted to the film mounts. In some embodiments, the stack of protective film layers may be provided to protect a lens of the camera. Similarly, the stack of protectors may be transparent, and the stack of protectors may be formed such that the outermost layer of the stack of protectors may be removed and discarded, and subsequent layers may then be removed and discarded as desired.

The frame may also include an opening configured such that the lens of the camera extends into the opening when the frame is mounted to the camera. An attachment mechanism may configured to removably and securely mount the frame to the camera. The attachment mechanism may constricts the frame around the lens of the camera to secure the frame to the camera.

In some embodiments, the lens of a mobile camera may be protected during an active sport, by providing the mobile camera having a lens, attaching a stack of tear-away camera lens protecting film layers to a mounting frame, removably attaching the mounting frame to the camera, using the mobile camera in an active sport, and removing a film layer from the stack while engaged in the active sport. The stack of tear-away camera lens protecting film layers may be positioned over the camera lens. A second a film layer may also be removed from the stack while engaged in the active sport.

In some embodiments, the mounting frame may include an opening with the lens of the camera extending into the opening when the mounting frame is mounted to the camera. The opening may have the same basic shape as the outer periphery of the lens of the camera. Removably attaching the mounting frame to the camera may include constricting the mounting frame around the lens of the camera, and the constricting may be performed by an adjustment mechanism that selectively constricts the mounting frame around the lens of the camera.

### BRIEF DESCRIPTION OF THE DRAWINGS

The following description can be better understood in light of Figures, in which:

FIG. 1 is an exploded view of an exemplary embodiment of removable camera lens protector mounting assemblies and stacks of protectors, along with a mobile camera;

FIGS. 2 and 3 are assembled isometric views of the embodiments of FIG. 1;

FIG. 4 is an isometric view of the removable lens protector mounting assembly of

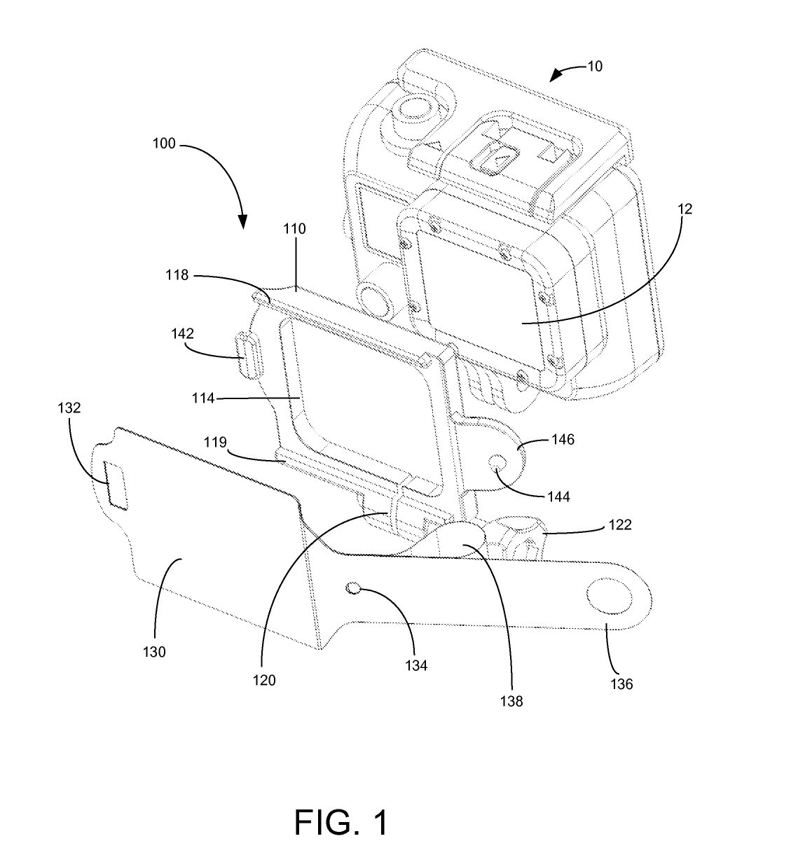

FIG. 1; and

FIG. 5 is a front view of the removable lens protector mounting assembly of FIG. 1.

Together with the following description, the Figures demonstrate and explain the principles of removable camera lens protectors. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry. For example, while the description below focuses on removable lens protector assemblies for use with a GoPro® camera, embodiments and methods may be useful, for example, to provide a quick, easy way to clear dirt, debris, or obstructions from the lens of any type of mobile camera, light, or other similar device while engaged in an activity.

Some embodiments may include providing a stack of tear-away transparent protectors or films for fast and easy mounting on to a camera lens. The tear-away transparent protectors may be provided in a stack of tear-away films. Embodiments may also include a mounting adaptor for mounting the stack of tear-away transparent protectors to a camera. The removable, tear-away protectors for cameras may be formed of thin pieces of transparent plastic film material that cover the camera lens without significantly altering the picture quality. When the camera lens vision is obscured due to accumulation of dirt or debris, the wearer can reach up and tear away the outermost layer of the stack of tear-off transparent protectors. The dirty protector may be removed and discarded providing the camera with a clear view through the camera lens and the remaining stack of transparent protectors.

Embodiments of the mounting system for adapting the tear-away protective films to a camera lens or protective cover of a personal, portable, camera may include an open clamping mounting frame, adapted to be tightened by a screw type mechanism, cam-lock mechanism, or any other suitable mechanism, for easy mounting and insuring a tight fit of the mounting system and stack of tear-away protectors to the camera. The clamping band may include a rubber lined inner wall for scratch resistant protection and quality grip to the camera lens outer shell, or protective cover. The mounting system may also include a durable outer face which includes the molded pegs positioned on opposite sides of the outer face of the mounting bracket.

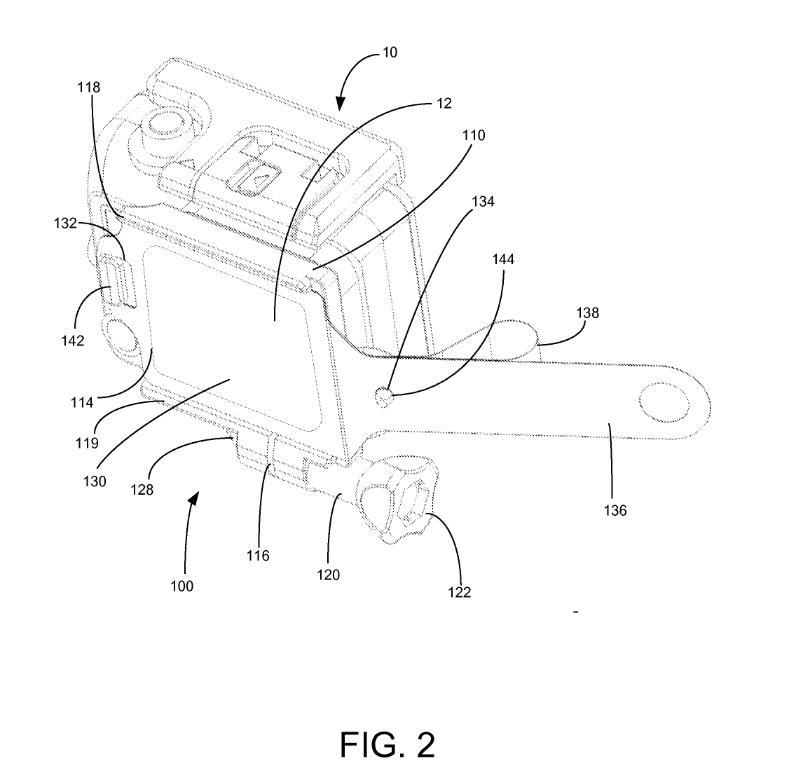

Turning now to the Figures, FIG. 1 shows an exploded view of an exemplary removable camera lens protector assembly 100 along with camera 10 having lens 12. FIGS. 2-5 illustrate various views of removable camera lens protector assembly 100. Removable camera lens protector assembly 100 may include a mounting frame 110, camera attachment mechanism 120, and tear-away protective film 130.

Mounting frame 110 may provide a mounting mechanism to hold one or more protective film 130 in front of lens 12 of camera 10. Mounting frame 110 may provide a general interior opening 114, or ring, corresponding to the outer shape of camera lens 12 protruding from camera 10. Mounting frame 110 may include an adjustment opening 116 to provide for a friction fit on lens 10 by using attachment mechanism 120 to reduce the size of opening 116, thereby causing opening 114 to become smaller and mounting frame 110 to constrict around an outer periphery of lens 12 to securely hold mounting frame 110 to camera 10.

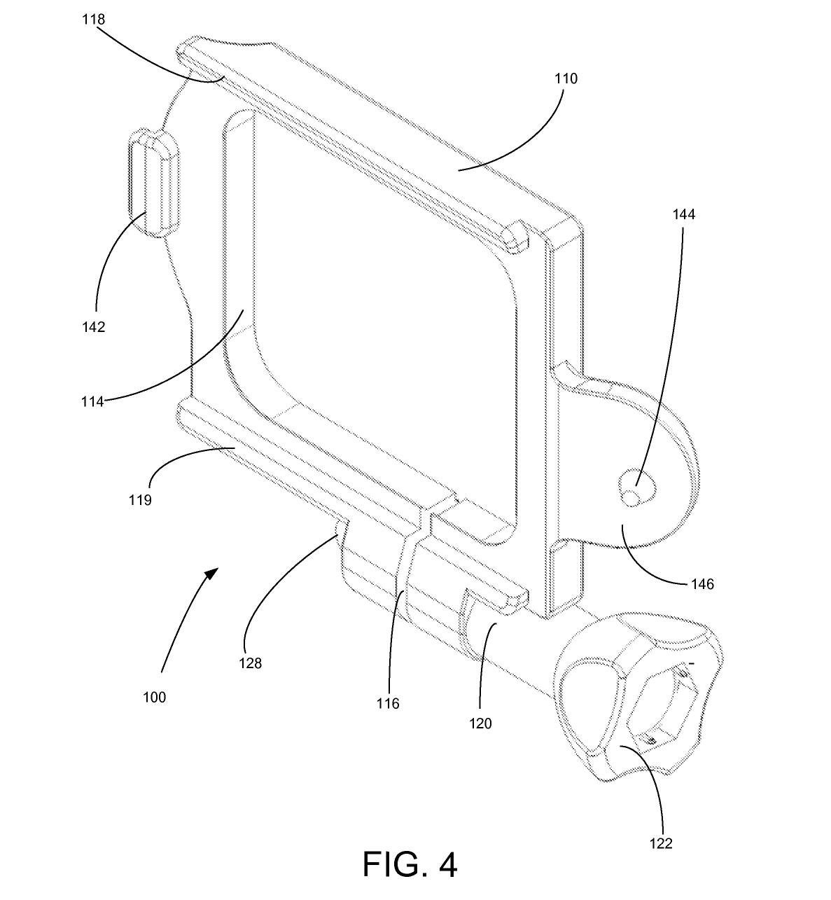

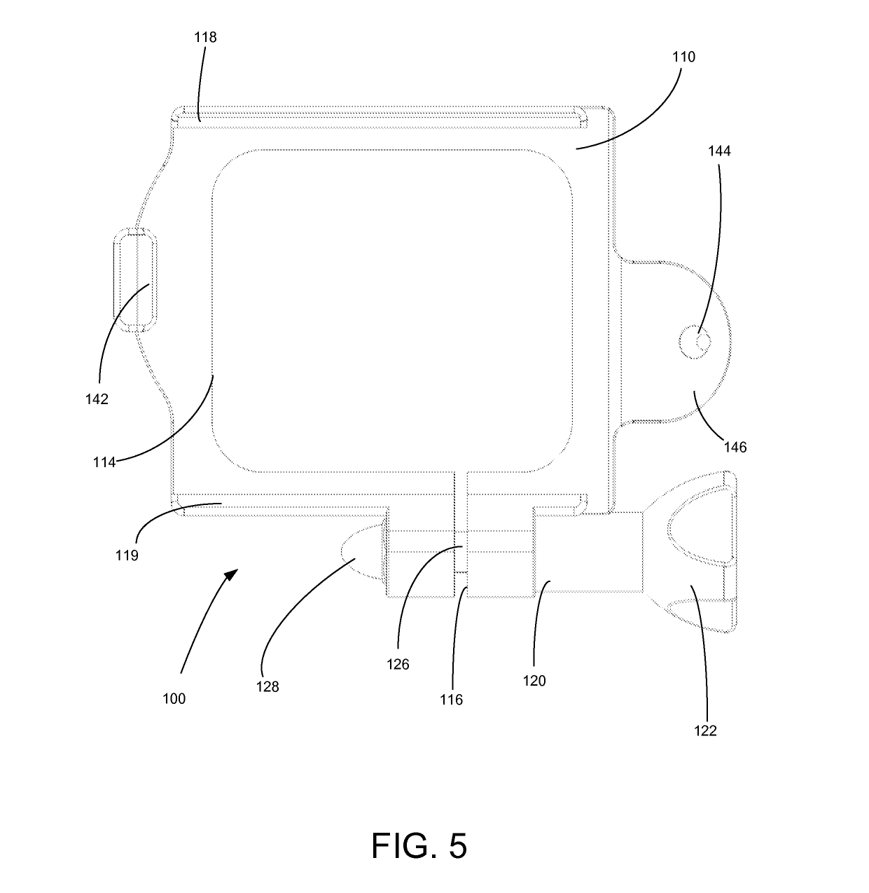

Attachment mechanism 120 (best shown in FIGS. 4 and 5), may be provided to removably attach mounting frame 110 to a camera such as camera 10. As shown in the Figures, some embodiments of attachment mechanism 120 may include adjustment knob 122, shaft 126, and retainer 128. In such embodiments, knob 122 may be rotated to turn shaft 126 within retainer 128 to decrease the width of space 116. This may be accomplished by shaft 126 having a threaded portion which screws into a cooperatively threaded portion within retainer 128. As such, when knob 122 is rotated clockwise, threads on shaft 126 may advance into retainer 128, forcing knob 122 closer to retainer 128 and consequently squeezing both sides of space 116 together and making opening 114 smaller. When opening 114 is over lens 12, the squeezing may cause mounting frame 110 to grip the outer periphery of lens 12, thereby securing removable camera lens protector assembly 100 to camera 10.

In other embodiments, an attachment mechanism may be a camming mechanism for squeezing space 116 smaller, or any other similar adjustment and fastening mechanisms suitable for forcing the two opposing pieces together such as the portions of mounting frame 110 on either side of space 116, thereby securing removable camera lens protector assembly 100 to a camera, as described above.

Mounting frame 110 may further include tear-away film stack mounting portions 142, 144 that cooperate with corresponding openings 132, 134 in each tear-away protective film 130 of stack 138. Tear-away protective film stack 138 may include several individual tear-away protective films 130. Tear-away protective film stack 138 may generally cover opening 114 in mounting frame 110 to protect lens 12 when mounted to camera 10. Each protective film 130 may include an elongated tab or handle 136 extending away from mounting frame 110 to allow a user to grasp handle 136 when it is desirable to remove a top layer of protective film from tear-away protective film stack 138. When in place, stack 138, and each tear-away protective film 130 in stack 138 may be held in place on mounting frame 110 through mounting portions 142, 144 that extend through openings 132, 134, respectively, on portions of each protective film 130 in stack 138.

Mounting portion 142 may be located on one edge of mounting frame 110 and mounting portion 144 on an opposing edge of mounting frame 110 across from opening 114. In some embodiments, mounting portion 144 may be located on flange 146, which may extend from mounting frame 110 at a slight angle from a face of mounting frame 110 to provide some pull for tear-away protective stack 130 to lie against mounting frame 110. Mounting portion 142 may provide an undercut portion to secure tear-away protective film stack 138. Similarly, mounting portion 144 may also provide an undercut portion that allows the stack 138 to be held under the undercut portion until the top protective film 130 is removed from the stack 138.

Mounting frame 110 may also include ridges 118, 119 to protect top and bottom edges of stack 138 when attached to mounting frame 100. Ridges 118, 119 may reduce wind and water, dust, and other debris from penetrating between stack 138 and lens 12. Ridges 118, 119 may also provide additional stability to stack 138 to reduce or illuminate any movement of stack 138 when mounted to provide a better picture quality for the camera.

Additionally, the stack 138 may be held together with an adhesive on one or more edges of the stack 138 that allows individual films 130 to be removed from the stack 138 one at a time. In other embodiments, a weak heat or static bond may hold the various films 130 together in stack 138 which allows each film 130 to be removed as desired while maintain the rest of stack 138 together. Each stack 138 may include as few as two, or as many as 25, or even more individual tear-away protective films 130.

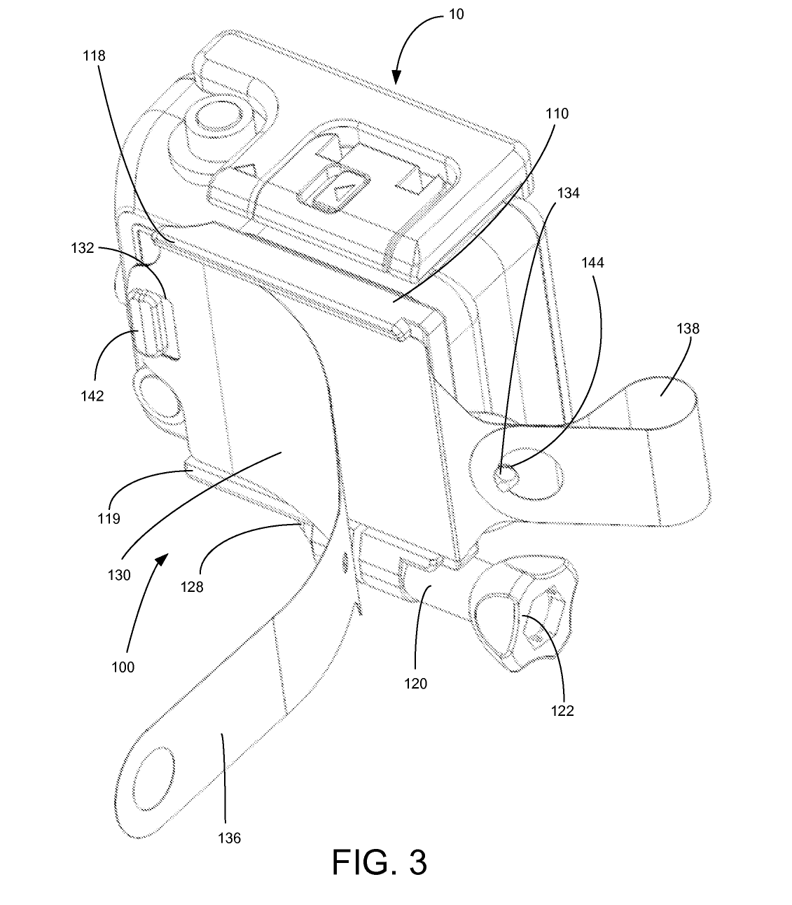

As shown in FIG. 3, top protective film 130 may be removed by grasping handle 136 (or elongated tab) and pulling across mounting frame 110 towards mounting portion 142, which causes opening 134 to first disengage from mounting portion 144 and then opening 132 to disengage from mounting portion 144, thereby releasing the top layer from stack 138 and exposing a new top film 130. When a top film 130 is removed, the next film may be exposed in stack 138 and handle 136 may then automatically extend. When held in stack 138, each tear-away protective film 130 may be held together except the handles 136, which may be doubled back and folded in such a way that the handles of lower protective films in the stack 138 are held in the folded configuration except the top-most film 130, where the handle 136 extends due to the resiliency of the flexible, transparent material forming each film layer 130.

Each tear-away film 130 may be formed of a transparent film of plastic, such as BoPET (biaxially-oriented polyethylene terephthalate), or other suitable materials. The tear-away films may be have a thickness and may be formed similarly to tear-offs commonly used with goggles. In some embodiments, the tear-away films may have a glare-resistant coating or may be tinted to provide a desired camera effect.

Mounting frame 110 may be formed of a durable plastic material or may be formed of metal or any other material suitable for securing tear-away protective films onto a camera. In some embodiments, a rubber or other pliable layer may be included on the inner surface of opening 114 to provide additional grip of mounting frame 110 to lens 12, or to provide some protection against scratching or otherwise damaging portions of camera 10.

As will be apparent to those skilled in the art in which the invention is addressed, the present invention may be embodied in forms other than those specifically disclosed above without departing from the spirit or potential characteristics of the invention. Particular embodiments of the present invention described above are therefore to be considered in all respects as illustrative and not restrictive. The scope of the present invention is as set forth in the appended claims and equivalents thereof rather than being limited to the examples and embodiments contained in the foregoing description.

1. An assembly for mounting removable protectors from a camera, the assembly comprising:
a mounting assembly, the mounting assembly including;
a frame configured to be mounted to a camera, and
film mounts extending from the frame; and
a stack of protective film layers configured to be mounted to the film mounts, wherein the stack of individually removable protective film layers is configured to protect a lens of the camera.

2. The assembly of claim 1, wherein the stack of protectors is transparent.

3. The assembly of claim 1, wherein the stack of protectors is formed such that the outermost layer of the stack of protectors may be removed and discarded, and subsequent layers may then be removed and discarded as desired.

4. The assembly of claim 1, wherein the frame includes an opening configured such that the lens of the camera extends into the opening when the frame is mounted to the camera.

5. The assembly of claim 1, further comprising an attachment mechanism configured to removably and securely mount the frame to the camera.

6. The assembly of claim 5, wherein the attachment mechanism constricts the frame around the lens of the camera.

7. The assembly of claim 1, further comprising upper and lower protective ridges.

8. The assembly of claim 1, wherein the opening has the same basic shape as the outer periphery of the lens of the camera.

9. A method of protecting the lens of a personal, portable camera during mobile activity, the method comprising the steps of:
providing the personal, portable camera having a lens;
attaching a stack of tear-away camera lens protecting film layers to a mounting frame;
removably attaching the mounting frame to the camera;
using the personal, portable camera in mobile activity; and
removing a film layer from the stack leaving a remaining quantity of film layers in the stack while engaged in the mobile activity.

10. The method of claim 9, wherein the stack of tear-away camera lens protecting film layers is positioned over the camera lens.

11. The method of claim 10, wherein the stack of film layers is transparent.

12. The method of claim 9, further comprising removing a second a film layer from the stack while engaged in the mobile activity.

13. The method of claim 9, wherein the mounting frame includes an opening and the lens of the camera extends into the opening when the mounting frame is mounted to the camera.

14. The method of claim 13, wherein the opening has the same basic shape as the outer periphery of the lens of the camera.

15. The method of claim 9, wherein the removably attaching the mounting frame to the camera includes constricting the mounting frame around the lens of the camera.

16. The method of claim 15, wherein the constricting is performed by an adjustment mechanism that selectively constricts the mounting frame around the lens of the camera.

17. The method of claim 9, wherein the mounting frame includes upper and lower protective ridges located above and below the stack.
